(19) United States
(12) Patent Application Publication
(10) Pub. No.: US 2023/0186601 A1
(43) Pub. Date: Jun. 15, 2023

(54) MODEL-BASED MACHINE-LEARNING AND INFERENCING

(71) Applicant: SeeChange Technologies Limited, Manchester (GB)

(72) Inventors: Timothy David HARTLEY, Chesham (GB); David Charles MCCAFFREY, Liverpool (GB); Michael Andrew PALLISTER, Beaconsfield (GB); Nimesh Naresh PATEL, Manchester (GB)

(21) Appl. No.: 17/912,238

(22) PCT Filed: Mar. 17, 2021
(86) PCT No.: PCT/GB2021/050669

§ 371 Date: Sep. 16, 2022

(30) Foreign Application Priority Data
Mar. 17, 2020 (EP) 20386015.0
May 18, 2020 (GB) 2007344.1
Jun. 4, 2020 (GB) 2008433.1

(51) Int. Cl. G06V 10/764; G06K 7/14

(52) U.S. Cl. CPC G06V 10/764; G06K 7/1447

(57) ABSTRACT

Apparatus having model-based machine learning and inferencing logic for controlling object transfer, comprises: an image input component to receive image data derived from a captured image of an object; a captured image classifier to 5 generate a first classification of the object by activating a trained model to analyse the image data; an input component to receive an object identifier for the object; an object identification classifier to generate a second classification of the object according to the object identifier; matching logic to detect failure to reconcile the first and second classification; heuristic logic responsive to the matching logic to 10 determine a causal factor in the failure; and training logic, operable when the heuristic logic determines that a causal factor in the failure to reconcile is a deficient first classification, to provide model training input comprising the image data and the object identifier to the model-based machine learning logic.

The present technology is directed to an apparatus and technique to support artificial intelligence machine learning and inferencing logic in computer systems that control object transfers. The apparatus may be provided as part of a machine learning system in the form of dedicated hardware or in the form of firmware or software code (or of a combination of hardware and code), to provide artificial intelligence engines (such as neural networks) with training inputs. Typically, the logic embodied in such artificial intelligence engines makes use of models to represent the real-world scenario about which the artificial intelligence engine is to make inferences. The models may be trained to provide outcomes that are based on probability weightings; in one example, a model may be trained to analyze image data captured by cameras, and to reason about the image data, making probabilistic inferences (such as specific identification or classification) about the objects from which the image data is derived.

Typically, artificial intelligence engines require repetitive training inputs from human operators; for example, an object to be identified is repetitively shown in various aspects to an image recognition system, along with input data identifying or classifying the object. The object may be, for example, an object that is to be transferred from one owner to another in a transaction, such as a trade or retail transaction, and it therefore needs to be accurately identified during its passage through the process of transferring ownership. In other cases, the object may be a loan or hire item, such as a library book or a rental vehicle, that needs to be transferred temporarily. In any case, there is a need for accurate classification or identification of the item, and this necessitates accurate training of the artificial intelligence system, so that captured images may be accurately associated with object identifiers and so correctly classified by, for example, a stock accounting system in a warehousing or retail environment. An object identifier may be derived from any one of a number of additional input mechanisms—for example, it may comprise a weighed produce identifier input by a user on a point-of-sale scale, a barcode read from a barcode scanning device, or a vehicle registration derived from a segment of an image of a vehicle.

In a real-world example, a retail item is repetitively presented to a camera at different angles and the operator enters an identifier, such as a universal product code (UPC) or global trade item number (GTIN), so that the image data derived from the camera captures can be matched with an identifier from, for example, a barcode scanner. After a number of repetitions, the system is trained to recognise and identify or classify the item correctly in at least a majority of cases. This training process requires the use of a human operator, and is typically very time-consuming and prone to human error. Further, any change in a product's appearance—for example, a change in the packaging shape, configuration or surface appearance—requires a return to the start of the process, and a new training process, with its disadvantages in time consumption and potential for error. The addition of new objects to the set of objects (for example, the addition of a new product to the range stocked by a retailer) requiring recognition and analysis presents a similar set of problems. Moreover, both object appearances may be in circulation at the same time, requiring the system to detect both older and newer versions of the item for a period of time. In addition, the capture and processing of the image data on which an artificial intelligence model is trained may be imperfect, leading to missing, low-fidelity, or otherwise deficient image data. Any such deficiencies are then reflected in, and affect, the performance, quality and accuracy of the inferencing that can be done using the model.

In addition to the model accuracy, there is also a desire to determine a mismatch between an identifier of a product and the classification performed by the artificial intelligence system. In a real-world implementation, self-checkout systems are becoming increasingly prominent, but retailers are identifying issues with customers misusing the system in a manner which has been proven to be difficult to detect. In one such example of misuse, a customer attempting to deceive the system may scan a barcode of a low-value item while actually taking a relatively higher-value item. The computing system may be configured to derive product characteristic data from image data captured from a camera which can be checked against the product identification data captured from a barcode reader (or other product identifier detector), to alert the retailer when a discrepancy arises to check the items taken and thereby prevent any theft by deception.

In a real-world implementation, product characteristic data derived from the image data captured from the camera can be checked against the product identification data captured from the barcode reader, to alert the retailer when a discrepancy arises that may be caused by a customer attempting to deceive the system by scanning the barcode of a low-value item while actually taking a high-value item. In such cases, the system is operable to alert the retailer to check the items taken and thereby prevent any theft by deception.

In a first approach to addressing some difficulties in supporting machine learning and inferencing logic in computer systems that control object transfers, the present technology provides an apparatus having model-based machine learning logic and inferencing logic for recording object transfer as a transactional computing event, comprising: an image input component operable to receive image data derived from at least one captured image of at least one said object; a captured image classifier operable to generate a first classification of said object by activating a trained model to analyse said image data; an object identification input component operable to receive at least one object identifier associated with said object; an object identification classifier operable to generate a second classification of said object according to said at least one object identifier associated with said object; matching logic operable to detect failure to reconcile said first classification and said second classification; heuristic logic responsive to said matching logic detecting said failure to reconcile and operable to determine at least one causal factor in said failure; training input logic, operable when the heuristic logic determines that at least one said causal factor in said failure to reconcile is a deficient first classification, to provide model training input comprising said image data and said object identifier to said model-based machine learning logic; accumulation logic operable in response to execution of said training input logic to accumulate a plurality of said captured images associated with said object identifier; accumulation verification logic responsive to said accumulation logic reaching a first threshold number of said plurality to initiate training on a training subset of said plurality; training logic, responsive to said accumulation verification logic reaching a first threshold, to train said model on said training subset to produce a testable model; training verification logic to quantify accuracy of said training of said model on said training subset with reference to a second threshold value of accuracy; testing logic, responsive to said training verification logic passing said second threshold value, to test said testable model on a test subset of said plurality with reference to a third threshold value of accuracy; and deployment logic operable to deploy said trained model to a plurality of devices in response to a determination by said testing logic that said accuracy has at least reached said third threshold value.

In a second approach to addressing some difficulties in supporting machine learning and inferencing logic in computer systems that control object transfers, the present technology provides an apparatus having model-based machine learning logic and inferencing logic for controlling object transfer, comprising: an image input component operable to receive image data derived from at least one captured image of at least one object; a captured image classifier operable to generate a first classification of the object by activating a trained model to analyse the image data; an object identification input component operable to receive at least one object identifier associated with the object; an object identification classifier operable to generate a second classification of the object according to the at least one object identifier associated with the object; matching logic operable to detect failure to reconcile the first classification and the second classification; heuristic logic responsive to the matching logic detecting the failure to reconcile and operable to determine at least one causal factor in the failure; training logic, operable when the heuristic logic determines that at least one causal factor in the failure to reconcile is a deficient first classification, to provide model training input comprising the image data and the object identifier to the model-based machine learning logic.

In a further approach, there are provided methods for controlling electronic apparatus, and the methods may be realised in the form of computer programs operable to cause a computer system to perform the process of the present technology.

Implementations of the disclosed technology will now be described, by way of example only, with reference to the accompanying drawings, in which:

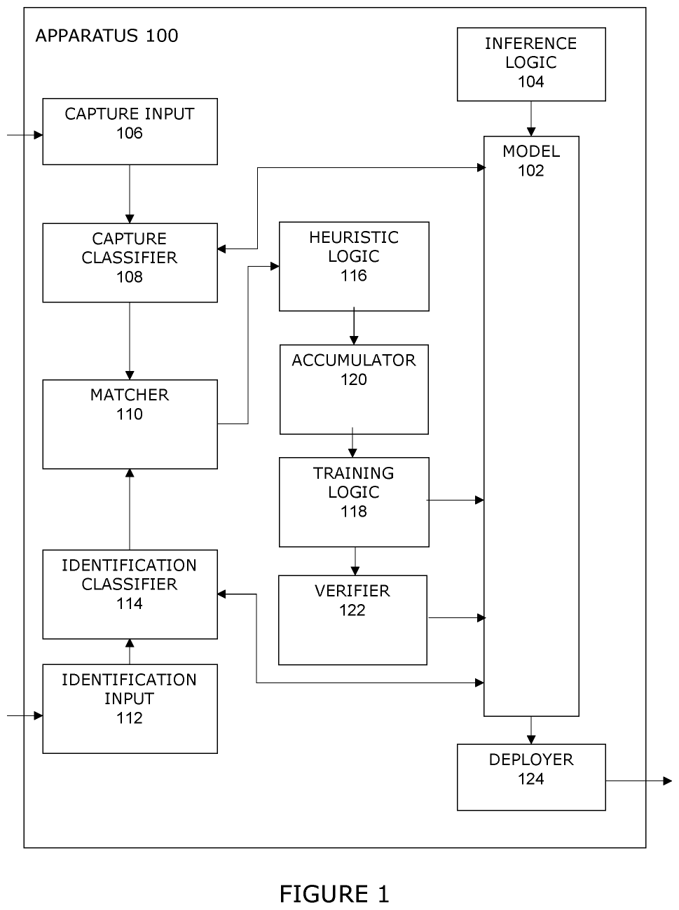

FIG. 1 shows a simplified example of a machine learning apparatus according to an implementation of the present technology and comprising hardware, firmware, software or hybrid components;

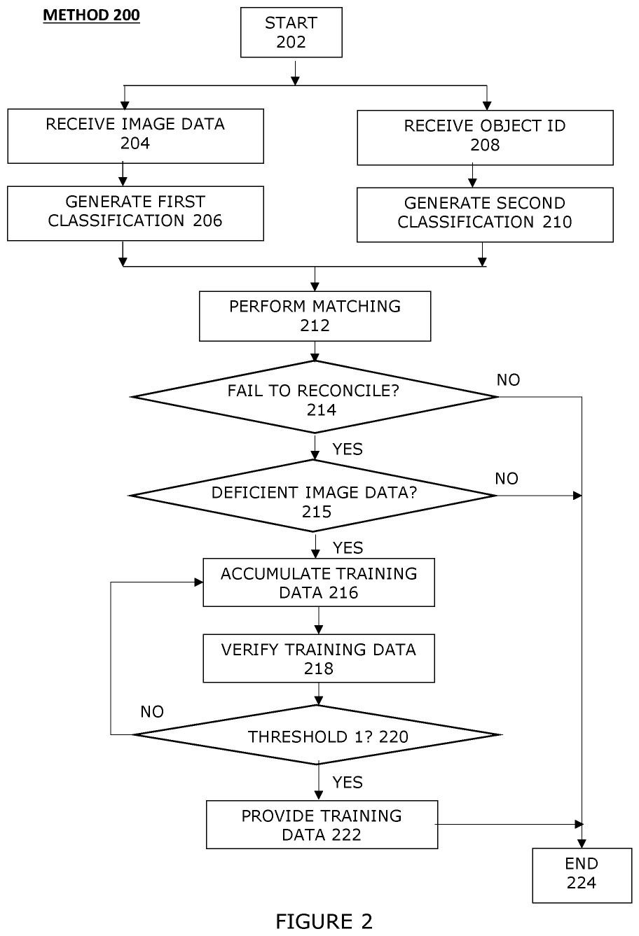

FIG. 2 shows a much-simplified representation of a method of operation of a model-based machine learning and inferencing apparatus according to an implementation of the present technology;

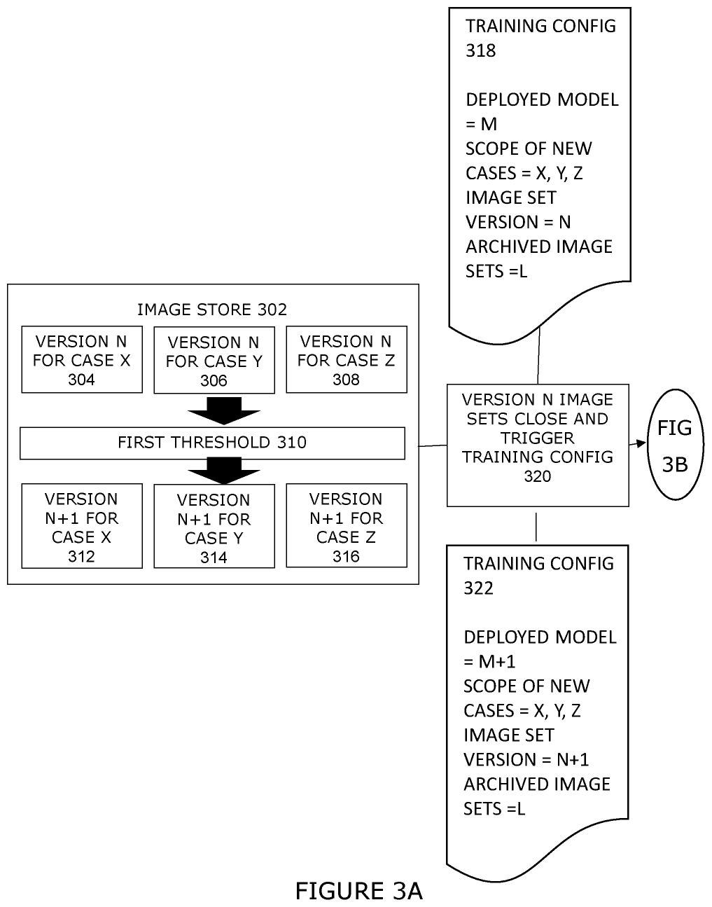

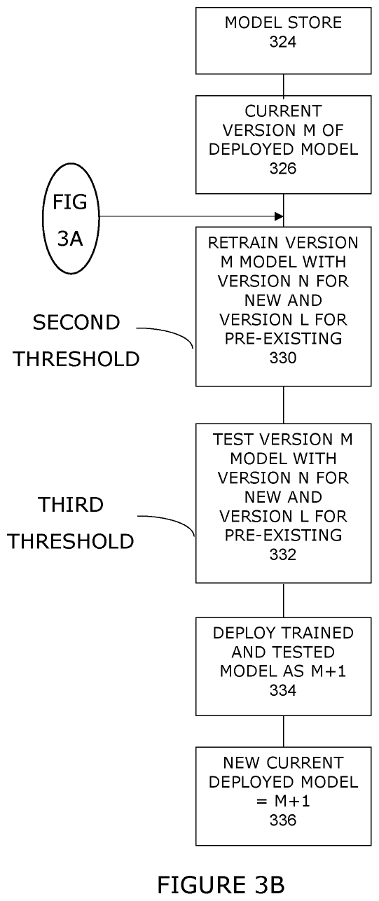

FIGS. 3A and 3B show an example of the dataflows in a model-based machine learning and inferencing apparatus according to an implementation of the present technology;

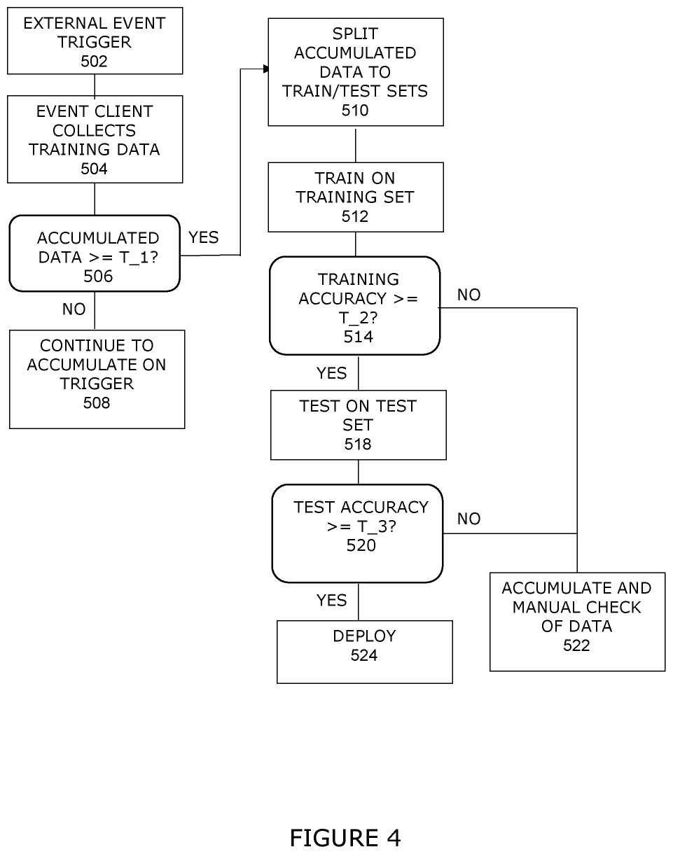

FIG. 4 shows a much-simplified representation of a method of operation of a model-based machine learning and inferencing apparatus according to an implementation of the present technology;

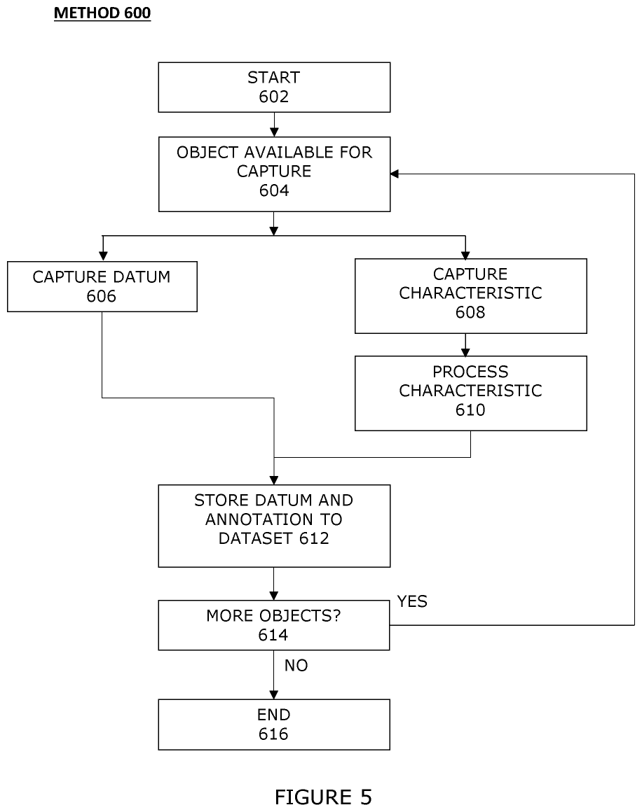

FIG. 5 shows one possible example of an annotation method for use in an implementation of the present technology;

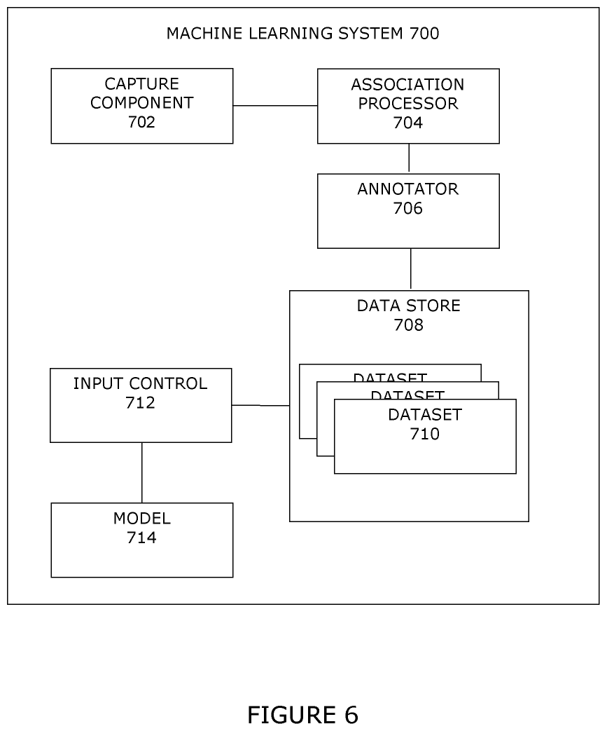

FIG. 6 shows a machine learning system suitable for the implementation of an annotation method for use in an implementation of the present technology; and

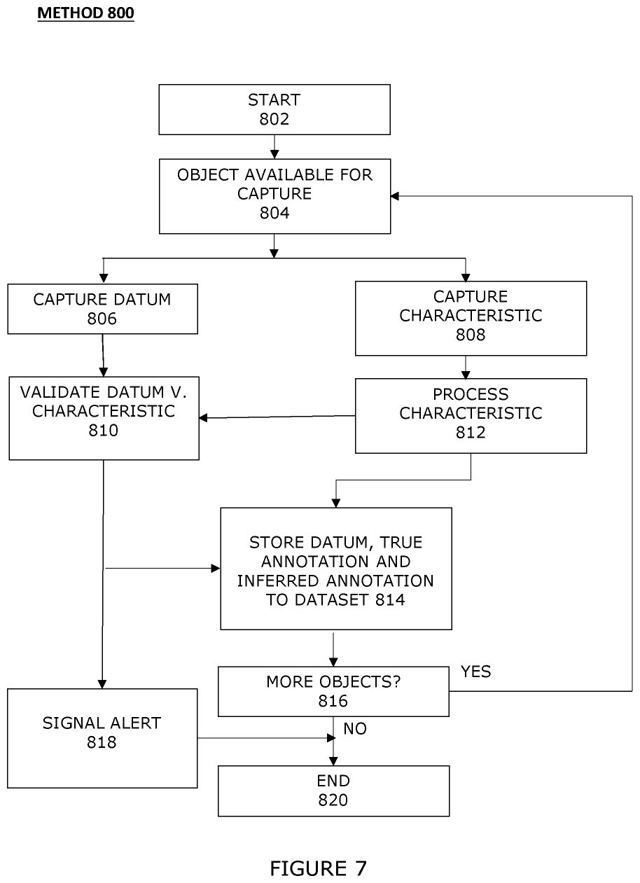

FIG. 7 shows a more detailed example of the operation of an annotation method for use in an implementation of the present technology.

For the training of machine learning systems, particularly neural networks of many types, it is necessary to have a large quantity of training data. Even when a system has been trained, for example using image data, any omissions or deficiencies in the image data used to train the model for an item can cause errors and necessitate retraining. The present technology provides a means whereby training data can be accumulated from multiple events to build a training input dataset, the process triggered when a failure to reconcile the image data in the model with the identifier (for example, a barcode) is determined to have been caused at least in part by missing, low-fidelity, or otherwise deficient image data that has previously been used to train the model. In effect, in such a situation the model has either not received any training data or has received training data but learned incorrectly, and in either case needs to be improved by providing training input that does not have the same deficiencies. In one concrete example, an object is presented for training in various positions and with various movements relative to a camera, but one aspect or movement has been omitted, or has been captured with low fidelity. In one example of the latter, an object may have been moved too quickly so that the camera has captured a low-resolution image, or the camera has temporarily malfunctioned, so that the captured image is distorted.

A failure to reconcile image data in the model with an identifier may also arise when no relevant data at all is available in the model to be reconciled with the newly received image data.

For new products (or products with new packaging) to be enrolled into the system, it is necessary for image data of the new products to be collected and annotated. This is a tedious and error-prone process, especially since the catalogue of store stock-keeping units (SKUs) may be very large and the rate of turn-over in terms of new product introductions and changes to packaging may be high. There is thus scope to automate the annotation process by operating a two-stage ML classification where the system first puts a bounding box round a detected (generic) retail object and then attempts to classify that object, based on the specific appearance of its packaging and shape, against a registered list of SKUs from the catalogue of store SKUs. This classification is used, in detection mode, to alert mis-matches between the ML model classified SKU and the bar-code SKU detected by the till scanner. If the bar code reader has detected a high value SKU and the ML model has failed to classify the retail object in the bounding box as being the same (high-value) SKU, it may be inferred that the shopper has honestly scanned the correct SKU and the mis-match is due to an ML model failure, due to the SKU being new or having changed packaging from the set of SKUs on which the model was previously trained. The image with the bounding box can be annotated with the honestly scanned SKU and the resulting annotated image can be used to re-train the model so that it can in future correctly detect this SKU. It is desirable to be able to automate this collection and annotation of image data based on event triggers. The aim is to create a data management pipeline to apply automated logic to the image capture and annotation process, bring the resulting annotated image data back to some central location where it can be processed through QA workflows to check its suitability for use in model re-training, and then feed that data into model re-training and validation work-flows.

In a further embodiment, the present technology may be applied to the correct detection and alerting of spills, such as those caused by dropped bottles in a retail environment such as a supermarket aisle. For a spill detection product to improve its ability over time to correctly detect spills and learn to differentiate true from false positives, the store security manager will be presented with spill detection alerts in a dashboard, along with an image of the spill which has been detected by the model. There will be an accept/reject button in the dashboard. If the manager presses reject, then the corresponding image needs to be tagged as a false positive (FP) and used to re-train the model. Conversely, if the manager discovers a spill which the model has failed to detect, then they can upload an image of the spill with a rough bounding box marked-up on it, and tag it as a false negative (FN) detection. Both sets of data, FPs and FNs, need to be collected from the streams running in local stores, and again brought back to some central location for QA processing followed by model re-training and validation. The continuing retraining and refinement of the model over time becomes fully automated.

In a further embodiment, the present technology may be applied as an infrastructure layer for a stock-on-shelves application—that is, an application that uses image scans and reference data to manage shelves in a retail environment. For a stock-on-shelves product to improve its ability to correctly detect products and voids on shelves, and to determine compliance with required stock layouts, especially when presented with new shelf layouts in stores where the solution is being newly configured, image data representing correctly stocked shelves needs to be collected and annotated from the streams running in local stores, and again brought back to some central location for QA processing followed by model re-training and validation. The trigger event here is likely to be a system integrator reviewing the streams in a dashboard and pressing a button when they observe (or are informed) that the shelf is correctly stocked or is empty or some state in-between. The corresponding image from the stream needs to be tagged with the appropriate compliance state. Again, over time, the model is retrained and refined using the present technology to the point where it is fully automated.

Turning to FIG. 1, there is shown a simplified example of an apparatus 100 according to an embodiment of the present technology and comprising hardware, firmware, software or hybrid components. In FIG. 1, apparatus 100 comprises at least one artificial intelligence model, which may comprise one or more neural network models, and which can be trained so that inferences can be made using the model by inference logic 104. As will be clear to one of ordinary skill in the art, the various components shown in FIG. 1 are representative, and in implementations, components shown together may be distributed across multiple devices and communicate via any suitable networking technology. For example, model 102 is shown in a single instance, but in implementation, instances of model 102 may be deployed in local devices.

In FIG. 1, apparatus 100 is operable in communication with external entities, such as cameras, barcode readers, other sensing and measurement devices, and external data processing systems, using any of the many available communication network technologies.

In the illustrative implementation shown in FIG. 1, capture input logic 106 and identification input logic 112 are operable to communicate with a network external to apparatus 100, as is deployer 124. Apparatus 100 is thus provided with input means to receive image data input derived from one or more images that were captured at capture input 106. The image data is typically derived from the camera captures by isolating features of the object of which the image is captured. Apparatus 100 is further provided with input logic to receive identification data input at identification input 112. In one example, capture input logic 106 is operable to receive image data derived from images from one or more cameras arranged to capture images of objects, while identification input logic 112 is operable to receive identification data, such as barcode data, from a barcode reader arranged to read barcodes associated with objects. Automatic character recognition of serial numbers, RFID and Qbit data may also be used as identification input. An object identifier may further be derived from any one of a number of additional input mechanisms—for example, it may comprise a weighed produce identifier input by a user on a point-of-sale scale, a barcode read from a barcode scanning device, or a vehicle registration derived from a segment of an image of a vehicle.

Capture input logic 106 is further operable to pass captured image data to capture classifier 108, and identification input logic 112 is operable to pass the received identification data to identification classifier 114. Capture classifier 108 and identification classifier 114 are operable to use model 102 and associated inference logic 104 to classify or otherwise identify, respectively, the image data and the identification data. In the above-mentioned real-world example, one or more captured images yield image data that enables capture classifier 108 to provide a first classification according to the object that it calculates has been imaged, while captured barcode data enables identification classifier 114 to provide a second classification according to the barcode that has been read. Matcher logic 110 is operable to receive the first and second classification and to attempt to reconcile them. In the event of a failure to reconcile the first and second classifications, heuristic logic 116 analyses the failure to determine the probable causal factors of the failure. Heuristic logic 116 may take the form of any of the known types of logic that can learn from repeated iterations of a process to derive inferences from data with which it is presented. In the present example, heuristic logic 116 has learned, e.g. from example data presented during a training phase, how to derive inferences as to the causes of failures. If the heuristic logic 116 determines that the failure to reconcile was caused by a deficient first classification, the images which were deficiently classified, and the corresponding object identifiers are accumulated in accumulator 120. When sufficient images have been so accumulated they are passed as training input to training logic 118 to update the weights or other parameters of model 102 and as test input to verifier 122 to test the accuracy of said update. The model training input comprises, but is not limited to, the image data and the object identifier. In one example, an object is scanned by a barcode reader, which provides an identification or classification; at or near the same time, a camera captures images of the object, from which image data is derived (by, for example, isolating a set of characterising features of the object). In the example, the set of characterising features has no corresponding data in the model 102, either because there was no relevant image data at the time the model was trained, or because the image data at that time was deficient in some other way—for example, if the captured images were of poor resolution. The failure to reconcile the object identifier with the model's view of the object is thus at least in part caused by this deficiency in the image data in the model, which implies that the model 102 requires training or retraining to improve its future performance. In the example, the current image data derived from the camera captures is associated with the identifier, and the data is added to a training dataset for use in training the model. Typically, the training data inputs are accumulated in the training dataset until there is sufficient data to pass a threshold, at which point, the common instances of model 102 may be retrained and deployed by deployer 124 to the local devices, such as the till, barcode and camera apparatus arrangements of a self-checkout station in a retail outlet. Typically, elements 102, 104, 106, 108, 110, 112, 114, 116 are all actually running in multiple local devices (till, barcode and camera apparatuses). They are all running the same version of the model 102. The detection by 110 of a failure to reconcile the two classifications, and the application of the heuristic logic in 116 to determine that the case was a deficient first classification, is happening on one of the local devices (as a shopper performs the till scanning and check-out). The training data instance (image+classifier) is sent up to the accumulator 120 in a central location, which is operating accumulator logic to accumulate training data instances from multiple local devices all separately recording reconciliation failures in their respective instances of the matcher 110. The accumulator 120 then activates training input logic to send the accumulated training data to 118 to re-train the common version of the model, and then verification in 122, and then deployment back to local devices of a new re-trained version of the model. In one implementation, the training data inputs may be verified by verifier 122 using verification logic before being supplied to train the model 102. In one implementation, there is provided a first threshold test on the quantity of current training data instances in accumulator 120. When the first threshold is exceeded, some of the accumulated training data is held back as a test or verification set (by some standard random but stratified test set sampling methodology which randomly holds back some number of images for each distinct bar code in the training set—the nature of the data is that image deficiency, the fact the multiple shoppers purchase the same bar code, and the use of a common model across multiple devices, leads to multiple instances of failure to reconcile on the same bar code, so for each bar code there may be multiple images which failed to reconcile with that barcode), the rest of the training data is sent to 118 to perform re-training of model 102 using training logic. The verification step 122 then tests, on the held back test data, that re-trained model 102 now achieves non-failed reconciliation of the test image with the corresponding test bar code (previously the model was failing to reconcile these images with the corresponding bar code). The training verification results are computed separately by the training verification logic for each bar code which exists in the training set, i.e. in the set of bar codes which have been failing to reconcile in the operation of the local devices. If the rate of non-failure of reconciliation for a given bar code exceeds a second threshold (of training accuracy), then that bar code is marked as “passed” in the re-training exercise. If the rate of non-failure for a given bar code is below the second threshold, then that bar code is marked as “failed” in the re-training exercise. In this case, the image+bar-code data (both test and training) for that failed bar code is sent back to the accumulator to form part of and await the accumulation of a new set of training data which exceeds the first quantity threshold, and be re-used in the next re-training exercise. These failures may also be notified to a system administrator to review the training data, and the first quantity threshold may be manually or automatically increased to generate a larger quantity of training data for the next re-training exercise. In an implementation described in detail with reference to FIG. 3 below, further testing logic may be applied to operate a further threshold test to test the trained model against a reserved set of test data. Again, if the threshold is not achieved, further accumulation logic is applied to accumulate training data for additional iterations of the training and testing logic. Either way, after the current re-training exercise, re-trained model 102 is deployed using deployment logic back to the local devices, in order to improve the classification of the “passed” bar codes.

Turning to FIG. 2, there is shown a much-simplified representation of a method of operation of a model-based machine learning and inferencing apparatus according to an implementation of the present technology.

In FIG. 2, following the START 202 of the method 200, image data derived from one or more captured images is received at 204, and at 206, the derived image data is used to generate the first classification. At 208, an object identifier is received, and at 210 the object identifier data is used to generate a second classifier. An object identifier may be derived from any one of a number of additional input mechanisms—for example, it may comprise a weighed produce identifier input by a user on a point-of-sale scale, a barcode read from a barcode scanning device, or a vehicle registration derived from a segment of an image of a vehicle. At 212, a match between the first and the second classifier is sought, and if, at test step 214, the match is successful, the current iteration of the method ends at END 224. If at test step 214, a failure to reconcile the first and second classifications is found, and if the heuristic logic indicates AT 215 that the failure is caused at least in part by deficiency in the image data, the training logic is invoked. Typically, training data is not provided to retrain the model until at least one threshold level is reached, as shown in the figure, and described above. However, in an alternative, the training data may be provided to the model immediately. In the figure, the failure to reconcile causes accumulation at 216 of training data comprising (but not limited to) image data and at least one object identifier. In one implementation, the accumulated quantity of training data may be verified against a threshold value (Threshold 1) at 218, 220. If the threshold level is not reached at test step 220, the process returns to accumulate further data at accumulate training data step 216 (which may involve iterations of other parts of the described method). If the threshold level is reached at test step 220, the training data is provided to the model at 222 and this iteration of the method completes at END 224. As will be clear to one of ordinary skill in the art, an end step of a machine-implemented method, such as the present END 224, may represent a return for one or more further iterations of the method, as necessary.

In an implementation of the above apparatus or technique, the technology comprises a retail control system, in which retail items are scanned by a camera to extract image data at the same time (or near the same time) as a barcode scanner operates to detect the product stock-keeping unit (SKU) identification. One implementation of the present technology thus provides an adaptive or self-learning capability for a retailer (such as a supermarket or convenience store), such that it can improve model performance by modifying the parameters of the model using data gathered either during a separate training period, or during normal use of the system.

A first assumption in this implementation is that the same model is deployed to many stores of the supermarket chain and to many tills within those stores, so the flow of bar code tagged images creates a continuous high-volume stream of tagged images of items with which the model can be periodically re-trained and updated.

The second assumption in this implementation is that the general rate of theft occurrence by deceptive scanning of items is stable over the long term, and that short run deviations from it are most likely due to model mis-classifications of items.

The implementation of the present technology is intended to supplement, not replace, any off-line capability for the operator of the system to explicitly train the model to recognize new products or products with changed packaging by either presenting it with externally generated tagged images of new products, or by explicitly bar code scanning new products and then presenting the new product to the camera in different poses for a defined period of time in order to generate a tagged set of training images.

The present implementation thus at least partially automates the training process when missing, low-fidelity, or otherwise deficient or defective image data is detected as a causal factor in a failure to reconcile the first classification based on image data derived from the camera capture and the second classification based on data derived from the barcode scanner. Failure to reconcile the first and second classifications may in one case be caused by a deficiency in the first classification arising from absence, from the training set used to train the machine learning logic on which the captured image classifier operates, of one or more image data representations corresponding to the second classification. In one specific example, this may be because the object that is imaged is wholly new to the system or is an existing product that has had its appearance changed to the point that it appears new. In the retail example, this may be because the product is newly entered to the system. The scanned barcode then matches a “slot” in the model for which there is no corresponding image data, and so it is the task of the present technology to enable the system to accumulate sufficient image data to provide effective training input to the model.

In another case, failure to reconcile the first and second classifications may be caused by a deficiency in the first classification arising from lack of fidelity, in the training set used to train the machine learning logic on which the captured image classifier operates, of one or more image data representations corresponding to the second classification. For example, the training set images may have been blurred or distorted at capture, and thus have caused the model to learn incorrectly the features on which it is to base the inferencing that identifies the object.

In a third case, failure to reconcile the first and second classifications may be caused by a deficiency in the first classification arising from the presence, in the training set used to train the machine learning logic on which the captured image classifier operates, of image data representations which have a preponderance of discrepant features with respect to the second classification.

In this case, a variant of the present technology may have the heuristic logic made operable to consult a reference database to determine whether the discrepant features are consistent with deceptive misidentification of an object. The reference database may be associated with monitoring logic that monitors instances of object transfer in the system to determine a normal rate of deceptive misidentification of objects and to populate the reference database with rate data for consideration by the heuristic logic.

If the heuristic logic, using the reference database, determines that the discrepant features are consistent with deceptive misidentification of an object, it can reject the captured image and object identifier from consideration as candidates for the model training input. It can then act in the conventional manner, by, for example, raising an operator alert to indicate that there is an above-threshold probability that the discrepant features are consistent with deceptive misidentification of an object.

As will be clear to one of skill in the art, the capture input logic 106 of the present implementation may differ from till to till to allow it to be tuned to account for differences in the camera position, lighting level, pixel density, reflectivity of the till surface, degree of occlusion, etc from one till to another, and the impact of these factors on the ability of the model to detect and localize retail objects. The model used by capture input logic 106 will conventionally be trained once for the specific environment of the till on which it is deployed and then not be re-trained unless something changes in the physical environment of the till, or some completely new category of retail items is introduced and needs to be detected by the model, e.g. if the supermarket introduces a range of electronic goods or clothing. The model used by capture classifier 108 is common across all tills and performs the task of classifying a cropped image of a detected and localized retail object as a specific retail item.

One implementation of the present technology provides an adaptive or self-learning capability in a system for preventing retail losses using a retail loss model such that the model can learn to adapt to changes in product packaging, or adapt to new products, by using the bar-code scan data of high value items from “honest” customers to generate tagged images of things which the model has been unable to classify or has mis-classified as low value. In this implementation a first assumption is that the product classification is naturally split into two product sets:
A short list of items of high value products which the model attempts to classify at individual SKU level;
A long list of items of all other SKUs in the supermarket inventory (referred to below as the low value or “other” category items) which the model only attempts to classify as not belonging to the high value list.

The second assumption is that the same model is deployed to many stores of the supermarket chain and to many tills within those stores, so the flow of bar code tagged images of high value items from “honest” customers (who self-identify themselves as honest by bar code scanning a high value item) creates a continuous high-volume stream of tagged images of high value items with which the model can be periodically re-trained and updated. As above, the third assumption is that the general rate of theft occurrence is stable over the long term, and that short run deviations from it are most likely due to model mis-classifications of low value items as high value. This creates a criterion for tagging images of mis-classified low value items as being in the “other” category.

The implementation of the present technology thus at least partially automates the training process for the ML vision model so that it adaptively updates its detection model to be able to:
Detect new high value items as items belonging to the high value list (assuming that the high value list has been updated to include the new item);
Detect changes in packaging of existing high value items as being still the same high value item;
Detect new “other” class items as being “other” class and not mis-classify them as a high value items; and
Detect changes in packaging of existing “other” class items as being still being an “other” class item, and not mis-classify them as one of the existing high value items.

In this implementation, the capture input logic 106 detects and localizes, i.e. puts a bounding box around, retail items in the video frame, at a granularity of detection corresponding to identifying typical retail object shapes, e.g. bottles, packets, bags, tins, cartons, shrink wrapped items, loose produce, etc.

The capture classifier logic 108 takes a crop of the detected and localized retail object and classifies as a specific retail item, either at the level of its product ID if it belongs to the high value item list, or as “Other” if not.

The product ID used to identify a retail item within the capture classifier logic 108 can be, for example, a UPC or EAN or IAN bar code, or it can be a stock-keeping unit (SKU) code used by the retailer, or any other form of unique ID. If the unique ID is not a bar code, then there needs to be a 1:1 mapping from the ID used in the capture classifier logic 108 to the bar codes which are generated by the bar code scanner.

The model needs to be trained initially on the starting high value item master list, and then re-trained periodically to either learn to classify new items which have been added to the high value list, or re-learn to correctly classify existing items in the high value list whose packaging and visual appearance have changed, or learn to correctly classify new “other” items or existing “other” items on which the packaging has changed as not belonging to the high value list.

The high-value item master list is supplied centrally and is common across all the tills and image processing units on which the system is running. The list is maintained by the inventory manager or stock manager of the supermarket chain. The manager adds new high value items to the master list and removes items which are no longer stocked as and when such changes occur.

In use, this implementation makes use of self-identified “honest” customers (those who have correctly barcode scanned at least one product that has been identified from its image as a high-value item) to provide the training data inputs for any new or changed products. Conversely, when a failure to reconcile the model's image data for the barcode with the image data that has been captured is consistent with deceptive misclassification (for example, when a customer attempts to steal by barcode scanning a low-value item, while the image shows a high-value item being taken), the image data and identifier data for this and any other items in the same session are excluded from use as training data input.

In more detail relating to the detection of events that indicate that retraining may be required, there may be provided an annotation event client operable in the machine-learning infrastructure. In one possible embodiment, an annotation event client will:

Run on the same gateway as the ML detection inference pipeline;

Listen for annotation trigger events from an external process, indicating a False Positive (FP) or False Negative (FN) or a compliance state;

Receive an input message consisting of:
Event header info, e.g. Stream ID, ID of person of process which generated the event, Date/time/location data with which to tag the event;
External image key or ID: the identifier used by the external process to identify the image frame to which the annotation data is to be attached;
Annotation meta-data: the ground-truth data to be attached to the image;

If necessary, make a call to an external process to reconcile the external image key with the internal image key scheme used in the transient image store. After this call, the external image key is replaced with an internal image key which is meaningful to the transient image store;

Make a call, using the internal message key, to a transient image store to retrieve the image to which the annotation meta-data is to be added. The transient image store is a buffer which contains, for a temporary period on a LIFO basis, all the images and detection meta-data which have been processed through the inference pipeline on the gateway. The storage time is long enough for the automated annotation process to be triggered and a call to be received from the event client asking for one of those images. After this call, the event message is enhanced with the image and detection meta-data matching the internal image key;

Send the completed message, containing image, detection meta-data and annotation meta-data, to local network storage where the annotated image will reside for a short period. A scheduled process on that local image store will later push the annotated images up to a central annotated image store in batch mode.

The above annotation event client may be implemented in several ways, and to support processing in the machine learning environment for different purposes.

In a first implementation, designed to provide ML infrastructure for a for a retail checkout loss awareness application (without barcode synchronization with the ML model), the annotation trigger event may operate as follows:

At the end of the checkout transaction, when the shopper presses “Proceed to pay”, the system determines whether or not there are any mismatches between the bar code list of SKUs (ignoring quantity) and the ML list of SKUs (ignoring quantity). If there is a mismatch and there is an unmatched high value SKU bar code, the system will generate an annotation trigger event containing the unmatched high value bar code and some synchronization data to allow matching to the corresponding FP ML detection. The event header data may be the store ID, till ID, stream ID, and/or the time and date of the “Proceed to pay” notification. The unmatched high value bar-code is the annotation meta-data in this case. The external image key data is the above-referenced synchronization data. The synchronization data may be for example the sequence order in which all the bar codes in the transaction were scanned, or a time stamp, or the like, provided that there is sufficient well-formed synchronization data.

Image key coordination is operated by way of a call to logic which matches the synchronization data to a specific frame UID or a frame time-stamp, for the frame or frames containing the mis-matched ML detection. The internal image key, as stated above, is some frame UID or a frame time-stamp which will uniquely identify the frame or frames in the terms in which it has (or they have) been processed by the inference pipeline. If there is some indeterminacy associated with the synchronization data, e.g., it only narrows the images down to a time range and not a specific frame, then the internal image key will be a vector of keys and not a scalar value.

Raw image collection is operated by way of a call to a local buffer of images of the items which have been scanned in the transaction, with their bounding boxes as generated by the ML model. The image and bounding box corresponding to the internal image key needs to be pulled from the temporary store (this could be a set of images if the internal key is a vector). The image, bounding box and the annotation meta-data (the correct high-value bar code) are pushed to an annotated local image store by an annotated image logger component.

In a further implementation, designed to provide ML infrastructure for a retail checkout loss awareness application (with barcode synchronization with the ML model), the annotation trigger event may operate as follows:

On a given scan, as soon as the theft alert model detects a mis-match between the bar code SKU of the current object in front of the scanner and the ML SKU classification of the same object, and if the bar code SKU is on the high value list, then the theft alert model should generate an annotation trigger event containing the mis-matched high value barcode and the precise time-stamp of the scan event. The event header data may be the store ID, till ID, stream ID, the time and date of the scan event, or the like. The unmatched high value bar-code is the annotation meta-data in this case. The external image key data is the precise time-stamp of the scan event.

A call is made for Image key coordination—this is a call to logic which converts the time-stamp of the scan event into a (single) frame ID. It is not required if the frames are uniquely identifiable by time stamp.

Raw image collection is again operated by way of a call to a local buffer of images of the items which have been scanned in the transaction, with their bounding boxes as generated by the ML model. The image and bounding box corresponding to the internal image key needs to be pulled from the temporary store (this could be a set of images if the internal key is a vector). The image, bounding box and the annotation meta-data (the correct high-value bar code) are pushed to an annotated local image store by an annotated image logger component.

In a further implementation, designed to provide ML infrastructure for a retail checkout loss awareness application (for items classified by type and, for example, weight), the annotation trigger event may operate as follows:

If the model either fails to classify items on the scale, or misclassifies, or only classifies down to a node in a class tree (e.g. apple, but not a specific type of apple), a customer may use the normal menu screen and presses the screen option for the correct fruit. The mis-match between customer choice and model classification is detected as an FP event, the image is tagged with the correct fruit/veg class, and the tagged image is sent to the local annotated image store.

In a further implementation, the system may be applied to the recognition of spill events, where a fluid has been inadvertently spilled on a surface, for example a retail store or warehouse unit floor. In an example, the store security manager presses the reject button on receiving a spill alert and reviewing the detected image on the dashboard. The event header data may be the store ID, stream ID, aisle ID, and the time and date of the spill alert. The annotation meta-data in this case is a “FP” tag to indicate that the event was a false positive. The external image key data is the stream and frame UID of the image in which the spill was detected and rejected. This may be a single frame or multiple frames depending on, for example, how many frames are shown to the manager to inform her accept/reject decision. In this example, there is no need for image key coordination, as the frames are keyed on the UID. A call is made to the raw image collector to retrieve the image corresponding to the given UID, plus a call to a local buffer of detection meta-data to retrieve the ML model spill mask for the same frame UID, or a call to a local transient image store (e.g. in gateway RAM) if the post-ML processed images are retained in the gateway temporarily. The image and the FP mask both need to be retrieved from their respective locations, and the image, spill mask and the annotation meta-data (the FP tag) are pushed to an annotated local image store.

In a further implementation, the system may be applied to the recognition of stock-on-shelves (for example, as a generic process for telling the model what a full/empty/half-full shelf looks like in a new store). In this implementation, the annotation trigger event is invoked when a systems integrator is observing the stream being processed by the gateway and presses a “capture” button in a dashboard to capture a state of stock on the target shelves. In the dashboard, she marks each shelf with a compliance score (0-100) and presses “submit”. The event header data may be the store ID, stream ID, aisle ID, shelf-stack ID, and a vector of shelf IDs within that stack. The annotation meta-data in this case may be a manually-assessed score (0-100) for each shelf in the stack. The external image key data is the stream and frame UID of the stream image at the point when the capture button was pressed. Because the frame is identifiable from the stream and frame UID, there is no need for image key coordination. The raw image collection comprises a call to a local transient image store for the frame identified by UID. The image and the automatically detected shelf masks both need to be retrieved. Some form of automatic shelf identification or other form of correspondence between the pixel mask of the area occupied by the shelf in the field of view of the camera stream and the aisle and shelf stack location of the same shelf in the physical world is required, as is the case for any stock on shelf system. The annotated image logger component pushes the image, the vector of shelf masks and the vector of manually-assessed compliance scores to an annotated local image store.

The detection of a trigger event thus causes the accumulation of annotated images in a store, where, as described above, the application of various thresholds controls when and how the ML model is retrained. The infrastructure of the presently-described technology, as would be clear to one of ordinary skill in the art, can be used to provide the support environment for many different ML applications, as shown in the descriptions of various implementations shown above.

In this implementation, a local image store accumulates annotated images generated by trigger events in a local deployed instance of the annotation event process. Temporary local image storage is used to avoid unmanageable network traffic being generated by the annotation event process running on a locally deployed device, given that the timings and frequency of annotation events is not known in advance.

Images from the local image stores may then be transported, in batch mode, to a central image store. The batch transport from local to central image store is managed by scheduled processes and organized to occur at times when network bandwidth is available for transporting image files, whose transport typically requires a high bandwidth. Different local image stores from different local deployments of the same annotation event process, i.e. from different local processes triggered by the same logical definition of event trigger, can all contribute to the same central image store. For instance, different self-check-outs all running the same item detection model, all scanning the same set of real-world retail items and all operating against the same list of high value items will all respond with the same annotation event to the same trigger of one of those high value items being identified by the bar code scanner on any of the check-outs and the common model failing to correctly classify that item, either because its packaging has changed from that on which the common model was trained, or because the item is newly added to the high value list and the common model hasn't yet been trained on it. The images from the different check-outs will be different but they will all contain an image of the same mis-classified retail item and they will all be annotated with the same bar code as identified by the respective scanners on the different check-outs.

Once the images have arrived in the central image store, they can be timed and dated, tagged by origin, tagged by annotated data (e.g. bar code) and accumulated into version controlled training and testing sets, for use in re-training the model.

The system supports two options for re-training the model, depending on the available time and compute resources. For maximum accuracy, the newly accumulated images are added to the full set of images which were previously used to train the model and the full training cycle is repeated on a combined set of existing images plus newly accumulated images, with the network being re-initialized at the start of training to some default set of starting weights. This first option takes longer and requires more compute resources, but generally produces more accurate results.

The second option is so-called transfer learning, in which training starts from the existing model weights and the network is trained only on the newly accumulated images. This is quicker and requires fewer compute resources, but is less accurate in some circumstances.

In the check-out application, either approach can be used, but the results will generally be more accurate using the first option. Under this first option, the system adds newly accumulated images for high value SKUs which have not been correctly classified by the model because they are either newly added to the high value list, or their packaging has changed from when the model was previously trained. In this latter case, there will be images of the same SKU present in the existing training, on which the model was previously trained. They should be removed from the existing training set. Images for said SKU are now supplied from the newly accumulated set.

If the second option is used for the check-out application, due to restrictions of training time and/or compute resources, then in the case of images of SKUs which appear in the newly accumulated images set due to the packaging of said SKUs having changed, the system relies on the transfer learning to suppress the network weight responses associated with the previous packaging images of said SKUs and to activate network weight responses associated with the new packaging of said SKUs. As mentioned above, this is inherently liable to be less accurate than doing a full network re-train.

In an application like spill detection, where the model is doing a two-way classification (spill/no-spill) and the accumulation of annotated false positive and false negative images is generating additional images of the same two classes (new spill images and new no-spill images), then transfer learning, i.e. the second option, is more applicable as an approach and gives a better trade-off of accuracy against training time and resource.

In the described implementation, the centrally accumulated images are organized into image stores. An image store contains versioned image sets. A UI page allows the creation and management of image stores, which are the central repositories of annotated images generated by the local annotation events, stored in local image storage and then transported in batches to the central image store.

A given image store is created and managed on an Image Store Details page. On this page the user defines the name of the image store, its central storage location, the local storage nodes from which it accumulates, the tags which are applied to images in the store to identify their provenance and date/time, the batch transport schedule for transporting images from local to central store and the image set versioning logic that determines when a new image set version is initiated and terminated within that image store.

An image store contains image set versions. These are created based on the provenance of images (as indicated by their tagging), date and time of generation of images and threshold number of images within the image set version. The user can manually clone an existing image set to create a new one, view the images in a set or delete a set. An image set can be subjected to computer vision operations such as applying rotations, colour filters, cropping, re-sizing, jitter, colour masking, blurring, etc in order to bootstrap training data. It can also be subjected to model based operations such as applying a supervisory model to tighten bounding boxes on annotated data. Similarity filtering can be applied to images in an image set to break the set down into smaller, more homogenous images sets.

Events where the system makes incorrect predictions expose improvement potential for the model. The original model in the system has been trained and tested on annotated data. Each subset of images in the training and testing datasets is of some size that is even across all subsets to maintain a balance. This number is the first threshold that the accumulation of new annotated data must be equal to or exceed.

An example of this is the self-checkout case. In this case, the accumulation of a piece of annotated data occurs every time there is a high value SKU scan and the model does not recognise it (the event trigger in this case). Image data is accumulated into separate sets for each high value SKU that is scanned and which the model does not recognise. The original model in this case has been trained and tested on a split of a number A of annotated images per set, i.e. per SKU. Therefore for this self-checkout case, the threshold number of accumulated annotated data that needs to be achieved is the predetermined number A for a new image set version, i.e. a set of images tagged with a given SKU, to be ready for the training phase. Once this has been achieved, the system splits the accumulated annotated set into a training set and testing set, ready for training. So in this case, the threshold is set based on the per case data set size which was used for initial training. All subsequent new cases are required to reach the same number of training images before they can be submitted, along with existing cases, for full model re-training.

As soon as the image set version for one SKU (call it X) which is either newly added to the high value list or whose packaging has changed, has reached the defined threshold of number A of images, then that image set version can be combined with the image sets for existing SKUs and the model can be re-trained on that combined set of images, assuming that the system is operating in option 1 mode of full model re-training.

Alternatively, if it is desired to wait until sufficient images have been gathered for some minimal number of new SKUs (say 3) before initiating a retraining cycle, and if those SKUs are represented as X, Y and Z, and assuming that annotated images for SKU X are flowing into the central image store faster than for Y or Z, then the system can close the image set version (call it N) for SKU X when it reaches the threshold of A, send new images of SKU X into a new version N+1 of the SKU X image set, whilst continuing to wait for the version N image sets for SKUs Y and Z to reach their thresholds of A images. When all 3 version N image sets, for SKUs X, Y and Z are closed, the system can submit those 3 images sets, along with the image sets for existing SKUs to full model re-training.

In the spills use case, where the system might realistically be operating in option 2 mode of transfer learning, then there are two image sets, one for newly identified spills (from annotated false negatives) and one for newly identified non-spills (from annotated false positives). The system waits until the current versions of both image set have reached some threshold and then submits the two images sets for transfer learning re-training. In this case, because the system is adding new images to an existing trained network, the threshold is determined not by considerations of the original data set size for each training case, but rather by consideration of how many new images will be required to make a significant difference to the weights of the already trained network, in order to justify firing up the compute to re-train them model, balanced against the rate at which newly annotated images are arriving and the cost of continuing to run with a deployed model which is known to have failed on some number of occasions.

In an implementation a control loop as shown in FIG. 3A may be used to determine what version of model and what version of image set to submit to the training phase when an image set version achieves the requires threshold content number of images. The references in the diagram to training and testing version M model on version N and version L image sets (for new and existing cases respectively) assumes that the image set for each training case is split into subsets for training and testing. In FIG. 3A, image store 302 contains image set versions 304, 306, 308 for various cases. If the image set versions pass threshold 310, they are admitted to the training inputs that are passed at 320 to FIG. 3B.

The scope of new training cases referenced in the training configuration in FIG. 3A may be determined in several ways. These include on an a priori basis, e.g. for the spills example the model is a two way classifier with two fixed classes (spill and no-spill) and these fixed classes form the new training cases by some external notification. For example, for the check-out instance, new SKUs appearing in the high value list will be notified by an external stock management system and will form one part of the new training cases by internal notification. For the check-out instance, an existing SKU which has appeared with new packaging and consequently is failing to be correctly classified by the deployed model instances will start to generate annotation events and accumulate images tagged with that SKU in the central image store. Given that this will happen across multiple check-outs and stores because they are all running the same model and the same packaging changes has occurred in all stores for the same SKU, the rate of accumulation of images in the central image store for this store will increase sharply above the trend rate of annotation events generated by average occurrence of random mis-classification of high value SKUs. When the rate of accumulation of images of an existing high value SKU exceeds this trend rate, then the given SKU is added to the scope of new training cases defined in the training configuration.

Image set definition may include the provenance of the images and be related to the deployment scope of the re-trained models. E.g. in the checkout example, we may have one version of the checkout model deployed in northern region stores and a second version deployed in southern region stores, maybe because a different range of stock is maintained in the two regions, or different self-checkout equipment is deployed in the two regions causing systematic differences in the lighting and background of the check-out images. In this case, we would construct image sets defined in terms of SKU and store region (north or south), so each SKU would have two associated image sets. The versions of those two images sets would then be managed separately, as would the versions of the deployed models. if the image sets for SKUs X, Y and Z achieved the first threshold for required number of images in northern region before the same occurred in southern region, then the northern region image set versions (version N for new cases plus version L for existing cases) would be sent at 320 to re-train (330 of FIG. 3B) and test (332 of FIG. 3B) the current deployed northern region model version (version M) and an updated version M+1 model is be deployed (334 of FIG. 3B) back down to the check-outs in northern region. The current image set versions for northern region would be incremented to version N+1. Meanwhile southern region would still be running with deployed model version M and current image set versions N for the same SKUs X, Y and Z.

In the training phase, the annotated image sets (of the appropriate version and cases scope according to the training config) that achieved the threshold number of images will be extracted and sent to the training and testing compute node.

The image set for each training case is split into training and test sets, according to some pre-defined proportions using standard methodologies. The training set is further split into training and validation sets according to some pre-defined proportions using standard methodologies.

In the above-referenced training option 1, training commences as a full retraining of the model on the training set which now includes the additional newly accumulated training set(s). During a training cycle, there is a training accuracy evaluated on the validation sub-set of data, that helps tune hyperparameters during training, and also gives an initial indication of the quality of the trained model.

This training accuracy is the second threshold (training accuracy threshold) that must be achieved so that the model can move onto the testing phase.

If this training accuracy threshold is not achieved, for those sets that fail to achieve it, further accumulation in a new image set version must occur. It might be necessary for manual investigation, using the above image set management workflow, to be undertaken to evaluate the quality of the training data. Multiple existing image sets for a given training case might be sub-sampled to generate a new image set of the required first threshold size for that case. Or poor quality images from the current version of the image set for the given case may be discarded and the, now reduced in size, image set left to wait for further accumulation to occur until it again reaches the first threshold. Or multiple existing image sets for the given training case might be analyzed for similarity, merged and then if necessary sub-sampled to generate a new image set of the required first threshold size for that case.

If this training accuracy threshold is achieved at 330, then the testing stage 332 can commence. The test set is already created at the start of the train stage from the newly accumulated image set version, and is accessible on the testing and training compute node. Once the training phase is complete and the training accuracy threshold is achieved by the newly trained model, this model needs to be tested on this unseen data (the test set).

These tests are defined per use case. The use case may include pre- and post-processing steps which are included in the full inference pipeline into which the model is deployed, e.g. pre-processing by models which are not part of the training cycle, cropping, filtering, etc.

The third threshold (test accuracy threshold) is the required test accuracy for an eligible model. This is generally defined with reference to the test accuracy of the initial model version. If this test accuracy threshold is not achieved, then further accumulation is needed for the sets where this is the case, as described under the training phase above, and the model cannot be deployed. Manual investigation might also be required. If the model achieves the test accuracy threshold for all accumulated image sets, then this model is said to be deployable.

In FIG. 4 is shown a general flow diagram for the completion of the process starting at the external trigger event 502 which may be, for example, the detection of one or more false positives or other discrepancies in the classification of an object. The event client (an implementation of which has been described above) accumulates 504 training data to be used as input to the ML model training process, until the number of data items in the set reaches 506 a threshold T_1. Until this threshold is reached the accumulation continues 508. On passing the threshold at 506, the accumulated data is split into a training and a test set at 510. The model is trained 512 using the training set until training accuracy passes threshold T_2 at 514. If the training threshold is not passed at 522, data continues to be accumulated at 522 and a manual check of the data may be instituted to detect any problems with the quality of the data being collected. Once the threshold T_2 has been passed at 514, at 518 the trained model is tested using the test set that was segregated at 510. If the test accuracy threshold T-3 is not passed at 520, data continues to be accumulated at 522 and a manual check of the data may be instituted to detect any problems with the quality of the data being collected. If the test accuracy threshold is passed at 520, the model is deployed at 524.

As will be clear to one of skill in the art, the difference between the training accuracy T_2 and the test accuracy T_3 is that a model is trained in a feedback loop of known inputs and outputs associated with the training images being applied directly to the input and output layers of the model. The accuracy that is being tested here at the end of the training phase is the intrinsic accuracy of the model, to assess whether or not training has “worked” terms to improve the fit of the model to the training set with which it has been presented.

By contrast, in the test phase, the model is placed into the inference pipeline in which it is proposed to be deployed back onto the local devices, where that pipeline will typically include various pre- and post-processing steps, or where the pipeline may combine the subject model with other models which are not part of the re-training cycle and are kept fixed. Testing will measure the accuracy of the re-trained model embedded in that inference pipeline, with the known inputs and outputs associated to the test images being applied to the input and output layers of the inference pipeline, and not directly to the re-trained model. Those test images will be subject to whatever pre- or post-processing occurs before or after the activation of the re-trained model.

For the training of machine learning systems, particularly neural networks of many types, it is necessary to have a large quantity of annotated training data. For each datum, representing an input to the neural network, there should be one or more annotations (also sometimes called labels) which contribute to the inferencing that defines the desired output(s) of the neural network when it receives the given datum as an input. Annotation types may include, but are not limited to, localization of a feature of interest within the input datum, and the type and/or some aspect of the nature of that feature or datum.

Such annotations may be created by the process of annotating (or labelling). Typically, this process involves humans manually adding the annotations to individual input datum using some form of annotation tool written in software. In sequence, each datum is presented to the annotator (or labeller) who creates the corresponding annotation; the datum/annotation pair is then exported to a format appropriate for input to the neural network training procedure.

In one example from the field of image recognition and classification described above, a human trainer examines a set of images captured by a camera that was positioned over a self-checkout till and determines that the images show in various aspects a specific product package. The trainer annotates the images with an identifier (such as a corresponding barcode or a weighing-scale product code) that identifies the product in the store's stock-keeping system. The paired image and identifier data can then be supplied as a training input to the machine-learning system, for use in normal operation to perform inferencing and draw conclusions about the goods presented to the checkout camera and the barcode reader. One possible use case for such a system after it has been trained is as a check on the correspondence between barcodes read and goods “seen” by the camera, in order to detect any instances of theft by deceptive scanning or keypad identification of a low-value product barcode while taking an item of a higher value. It is known, for example, for a customer to weigh a high-value item on the self-checkout scale, but to enter the code for a low-value item—for example, to deceptively misidentify expensive avocados as much cheaper carrots. It is also known for a customer to scan a barcode of a low-value item while taking a higher-value item of similar, but not identical appearance—taking a bottle of high-value wine while scanning the barcode of a low-value bottle. If a system is trained at a sufficiently detailed level of granularity in its image data, characterising features of a bottle's label may be used in conjunction with the tagging of the present technology to detect the substitution.

The trained system according to an implementation is operable to detect a discrepancy between the currently-input barcode or keypad identification and the barcode or keypad identification tag associated with the characterising data derived from the product images in the machine-learning system's model. The trained system will thus detect that the currently captured images that correspond to the trained image data are misidentified with respect to the barcode or keypad identification tag, and an alert can then be raised.

The training procedure of presenting items to a camera and identifying them is a labour-intensive process, and due to the large amounts of annotated data required for training neural networks, can incur a significant cost in skilled labour, machine time dedicated to training instead of “production” use, and other resources. As with all such processes, human error may also play a part in producing sub-optimal results.

In some cases, objects or features of interest, which through some representation are to be given as inputs to a neural network, may be known already to a system other than a neural network. The mechanism by which they are known may vary but could include such mechanisms as barcode, RFID or car number plate (sometimes called vehicle registration). Typically, the system may comprise databases or other tables of information that can be referenced using an index.

There is thus provided in the present technology a system for rapid annotation of training data whereby the known identifiers are made use of. In parallel, at the time of generating or collecting the input data (such as image data from camera captures) for the neural network, the known identifiers may be used to seek additional information in databases or other reference sources to generate the annotations.

One simple example is, at the time of collecting images of certain items, which are known to have a barcode, to also use some piece of equipment to collect the barcode of the item. The number represented by the barcode may be used directly as the annotation of the image. Alternatively the number may be processed into the annotation, deterministically, without human intervention. A simple example is lookup of the number in a table which contains the desired labels.

Even in the case where the known identifier mechanism is not reliable, a form of the rapid annotation can be performed. Following the machine-implemented annotation by use of the known identifier, the datum/annotation pairs can be presented to a human for review only.

Such a review process may, for example, consist of simply confirming that the annotation is correct, and if it is not correct, discarding the datum/annotation pair. Such a review process may still be significantly less labour-intensive than the process of creating the annotation entirely manually.

Other methods of automatic annotation may include mechanisms whereby the data are annotated by additional neural networks. In such cases a first neural network may process the data and the output of the neural network may itself be used as the annotation for the training of a new neural network. Such a system necessitates that the annotating neural network has itself already been trained with some quantity of data, enabling it to perform the labelling with some probabilistic accuracy. In such cases a similar human review process as described above may be used to review the data.

Using the known identifier may also enable improved annotations in this setting. In one case the known identifier may be used to enrich the annotations generated by the annotating network. For example, the annotating network may be trained only to produce annotations of the datum of a general type such as the general existence and/or localization of a feature of interest; the known identifier may be used to precisely determine the nature of the feature. In another case the known identifier may be used to create the training data required for the development of the annotating neural network.

The present technology may thus provide automated annotation (tagging) of captured data with context metadata in real time or near real time to allow automated inputs to AI model learning or inference scenarios), e.g. in reinforcement learning, hybrid learning and other active learning). This adds a new level of intelligence above current automated machine learning (ML) tools and systems by leveraging the intelligent automation of data annotation.

Turning to FIG. 5, there is shown a simplified example of an annotation process using visual image capture to provide inputs to a machine learning dataset.

In FIG. 5, following the start 602 of an annotation method 600, an object is made available for data capture 604 and at least one datum is captured at 606—in one example case, visual image data relating to characteristic forms and dimensions may be captured by a camera from an object placed in a capture area. In a separate line of processing, which may be synchronous or asynchronous, a further capture component is operable at 608 to capture a “known” characteristic of some kind that is related to the object under scrutiny.

The characteristic may be, in the example given above of a visual image, another visual element such as a universal product code, a barcode, a QR code, a numeric label, a vehicle registration, an image mark, or a logotype. It may also be a characteristic of an entirely different type—for example, a verbal input from a voice processor that states a characteristic of the object under scrutiny.

It will be clear to one of ordinary skill in the art that many other associations are possible, and that any such associations may be processed in a similar manner. The characteristic is processed at 610 (for example, by looking up reference data associated with a barcode or vehicle registration) to provide an annotation relating to the characteristic. At 612, the datum and annotation (or annotations) are stored in a dataset in a form that can be used as input to the training procedure of a machine learning model. If there are more objects 614 to be placed under scrutiny, the procedure returns to 604. If there are no further objects 614, the method ends at end step 616.

As would be clear to one of ordinary skill in the art, the data and the annotations taken together can build a more comprehensive input to a learning dataset.

This automated annotation of data with “intelligent metadata” offers a way to close the loop and provide usable inputs to the training procedure of the machine learning model into the model without human intervention.

The inputs elicited by the annotations may be derived or refined by reasoning over the annotated data using, to take the image data example again, known class data for a type of image. Inputs may also be obtained from an external source, such as a database of information about images or imaged objects. In one example, a vehicle may enter a camera capture zone and be identified as a vehicle of the class “truck”; simultaneously, its registration plate may be captured and looked up in a registration database, where the vehicle carrying that registration is identified as a truck of a certain weight and emissions class. Annotating the image data with this information may inform the reasoning of an ML system dedicated to traffic pollution or road-load control, for example when the same image is later identified at a different location in a road network having congestion controls or emissions zones.

In a further example, a set of images of a retail product may be captured by a camera at a point of sale and be annotated with a tag derived from an associated scan of a bar code of the same item. In production use, in a system where a camera supervises a self-checkout till at a store, the retail product's shape can be analyzed and identified by inferencing over a model that has been trained. In one implementation, the product and the associated identifier may be classified using the model as a high-value or low-value item. The annotated image data has thus been used as training input to the value classification model that can be used to identify deceptive misclassification of products at the checkout. During production use of the product recognition and classification model, when images matching the shape of the high-value item are recognised, but in association with a bar code that does not match the tag information, the inferencing engine may issue an alert signal indicating the discrepancy, for investigation by a store employee. Because of the sensitive nature of this activity—the potential for offending customers with over-zealous checking of their shopping—it is advisable to have a very accurate recognition and classification system, but this is costly in time and resource during the training process. Automation of the tagging process by means of the present technology is very helpful in such use cases.

Turning to FIG. 6, there is shown a simplified example of a machine learning system 700 according to an embodiment of the present technology and comprising hardware, firmware, software or hybrid components. In FIG. 6, capture component 702 is operatively linked to association processor 704, which determines associations for annotation and provides input to annotator 706. Annotator 706 is operable to process associations to provide annotations linked to data in the data store 708, where the linked data and annotations are stored in datasets 710. The linked data and annotations from datasets 710 are operable to be made available by input control 712 to the training procedure of model 714.

In an implementation, as described above, two models may be provided. The first model, when trained, operates to perform the recognition and discrepancy-detecting functions described above, while the second model, when trained, is operable to perform the association between the captured image datum and the additional characteristic that is used to provide the annotation. The models may comprise neural networks that are operable to make inferences, based on their training, about the data they receive as inputs, and to provide those inferences as output actions.

Turning to FIG. 7, there is shown a further method of operation of a machine learning system according to an embodiment of the present technology. In FIG. 7, following the start 802 of an annotation method 800, an object is made available for data capture 804 and at least one datum is captured at 806—in one example case, visual image data relating to characteristic forms and dimensions may be captured by a camera from an object placed in a capture area. In a separate line of processing, which may be synchronous or asynchronous, a further capture component is operable at 808 to capture a “known” characteristic of some kind that is related to the object under scrutiny. The characteristic may be, in the example given above of a visual image, another visual element such as a universal product code, a barcode, a QR code, a numeric label, a vehicle registration, an image mark, or a logotype. It may also be a characteristic of an entirely different type—for example, a verbal input from a voice processor that states a characteristic of the object under scrutiny. It will be clear to one of ordinary skill in the art that many other associations are possible, and that any such associations may be processed in a similar manner. The characteristic is processed at 812 (for example, by looking up reference data associated with a barcode or vehicle registration) to provide an annotation relating to the characteristic. The annotation derived from the characteristic at 812 is input along with the captured datum from 806 to a validation at 810, where a model validates the datum against the characteristic, an if a mismatch is determined, causes an alert signal to be emitted at 818. The validated datum, its true annotation and any inferred annotation are stored at 814 in a form that can be used as input to the training procedure of a machine learning model. If there are more objects 816 to be placed under scrutiny, the procedure returns to 804. If there are no further objects 816, the method ends at end step 820.

In FIG. 7, VALIDATE DATUM V. CHARACTERISTIC 810 comprises a model that may have been trained on either a standalone bootstrapping dataset or on a previous period of execution of the system according to FIG. 5, described above. In particular it has been trained to infer an annotation (characteristic) from the data alone. Further, with access to the captured and processed “true” annotation it may compare its own “inferred” result with the “true” result.

This mechanism of comparison may be as simple as “the same or not”, but may also be somewhat more complex, recognising the fact that machine models produce some probabilistic output rather than a completely deterministic answer. For example, over time, one may collect empirical error measurements for a given model, and identify through Bayesian statistics when the inferred annotation and true annotation differ by some statistically derived threshold. This means to detect when a model's error is considerably outside normal operating conditions. In such cases there exist two possible reasons, that the model itself is working poorly, or that the “true annotation” is itself not accurate.

This could be caused, in the context of a retail POS machine for example, by somebody fraudulently masking or replacing the barcode of an expensive item, with one from a cheaper item. Such occurrences are especially useful in two separate ways. In one way such occurrences may be used to alert human supervisors of such a system to possible fraudulent activity. Such an alert can be in multiple forms including a visual or audio alarm, or notification delivered through e-mail or other message format, or notification to some other application by means of a message e.g. an HTTP request. In another such way the dataset being stored for further training can be enriched substantially by such annotations. Such pairs of annotation (true and inferred) may be incorporated into the training of the next version of the validating model (810). For example cases where the annotations differ could be given a higher weight in the training, effectively forcing the model to pay more attention to those samples versus samples where it may be working effectively anyway.

As will be appreciated by one skilled in the art, the present techniques may be embodied as a system, method or computer program product. Accordingly, the present technique may take the form of an entirely hardware embodiment, an entirely software embodiment, or an embodiment combining software and hardware. Where the word “component” is used, it will be understood by one of ordinary skill in the art to refer to any portion of any of the above embodiments.

Furthermore, the present technique may take the form of a computer program product tangibly embodied in a non-transient computer readable medium having computer readable program code embodied thereon. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object-oriented programming languages and conventional procedural programming languages.

For example, program code for carrying out operations of the present techniques may comprise source, object or executable code in a conventional programming language (interpreted or compiled) such as C, or assembly code, code for setting up or controlling an ASIC (Application Specific Integrated Circuit) or FPGA (Field Programmable Gate Array), or code for a hardware description language such as Verilog™ or VHDL (Very high speed integrated circuit Hardware Description Language).

The program code may execute entirely on the user's computer, partly on the user's computer and partly on a remote computer or entirely on the remote computer or server. In the latter scenario, the remote computer may be connected to the user's computer through any type of network. Code components may be embodied as procedures, methods or the like, and may comprise sub-components which may take the form of instructions or sequences of instructions at any of the levels of abstraction, from the direct machine instructions of a native instruction-set to high-level compiled or interpreted language constructs.

It will also be clear to one of skill in the art that all or part of a logical method according to embodiments of the present techniques may suitably be embodied in a logic apparatus comprising logic elements to perform the steps of the method, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored using fixed carrier media.

In one alternative, an embodiment of the present techniques may be realized in the form of a computer implemented method of deploying a service comprising steps of deploying computer program code operable to, when deployed into a computer infrastructure or network and executed thereon, cause the computer system or network to perform all the steps of the method.

In a further alternative, an embodiment of the present technique may be realized in the form of a data carrier having functional data thereon, the functional data comprising functional computer data structures to, when loaded into a computer system or network and operated upon thereby, enable the computer system to perform all the steps of the method.

It will be clear to one skilled in the art that many improvements and modifications can be made to the foregoing exemplary embodiments without departing from the scope of the present disclosure.

1. An apparatus having model-based machine learning logic and inferencing logic for recording object transfer as a transactional computing event, comprising:
an image input component operable to receive image data derived from at least one captured image of at least one said object;
a captured image classifier operable to generate a first classification of said object by activating a trained model to analyse said image data;
an object identification input component operable to receive at least one object identifier associated with said object;
an object identification classifier operable to generate a second classification of said object according to said at least one object identifier associated with said object;
matching logic operable to detect failure to reconcile said first classification and said second classification;
heuristic logic responsive to said matching logic detecting said failure to reconcile and operable to determine at least one causal factor in said failure;
training input logic, operable when the heuristic logic determines that at least one said causal factor in said failure to reconcile is a deficient first classification, to provide model training input comprising said image data and said object identifier to said model-based machine learning logic;
accumulation logic operable in response to execution of said training input logic to accumulate a plurality of said captured images associated with said object identifier;
accumulation verification logic responsive to said accumulation logic reaching a first threshold number of said plurality to initiate training on a training subset of said plurality;
training logic, responsive to said accumulation verification logic reaching a first threshold, to train said model on said training subset to produce a testable model;
training verification logic to quantify accuracy of said training of said model on said training subset with reference to a second threshold value of accuracy;
testing logic, responsive to said training verification logic passing said second threshold value, to test said testable model on a test subset of said plurality with reference to a third threshold value of accuracy; and
deployment logic operable to deploy said trained model to a plurality of devices in response to a determination by said testing logic that said accuracy has at least reached said third threshold value.

2. An apparatus having model-based machine learning logic and inferencing logic for controlling object transfer, comprising:
an image input component operable to receive image data derived from at least one captured image of at least one said object;
a captured image classifier operable to generate a first classification of said object by activating a trained model to analyse said image data;
an object identification input component operable to receive at least one object identifier associated with said object;
an object identification classifier operable to generate a second classification of said object according to said at least one object identifier associated with said object;
matching logic operable to detect failure to reconcile said first classification and said second classification;
heuristic logic responsive to said matching logic detecting said failure to reconcile and operable to determine at least one causal factor in said failure; and
training logic, operable when the heuristic logic determines that at least one said causal factor in said failure to reconcile is a deficient first classification, to provide model training input comprising said image data and said object identifier to said model-based machine learning logic.

3. The apparatus of claim 1, said providing model training input to said model-based machine learning logic operable to address said failure to reconcile said first classification and said second classification by modifying the parameters of the model to improve model performance.

4. The apparatus of claim 1, said heuristic logic operable to determine that said failure to reconcile said first classification and said second classification is caused by a deficiency in said first classification arising from absence, from the training set used to train said machine learning logic on which said captured image classifier operates, of one or more image data representations corresponding to the second classification.

5. The apparatus of claim 1, said heuristic logic operable to determine that said failure to reconcile said first classification and said second classification is caused by a deficiency in said first classification arising from lack of fidelity in the training set used to train said machine learning logic on which said captured image classifier operates, of one or more image data representations corresponding to the second classification.

6. The apparatus of claim 1, said heuristic logic operable to determine that said failure to reconcile said first classification and said second classification is caused by a deficiency in said first classification arising from the presence, in the training set used to train said machine learning logic on which said captured image classifier operates, of image data representations which have a preponderance of discrepant features with respect to the second classification.

7. The apparatus of claim 6, said heuristic logic further operable to consult a reference database to determine whether said discrepant features are consistent with deceptive misidentification of an object.

8. The apparatus of claim 7, said heuristic logic further operable to reject said at least one captured image and said object identifier as candidates for said model training input responsive to an above-threshold probability that said discrepant features are consistent with deceptive misidentification of an object.

9. The apparatus of claim 7, said heuristic logic further operable to raise an operator alert responsive to an above-threshold probability that said discrepant features are consistent with deceptive misidentification of an object.

10. The apparatus of claim 7, further comprising monitoring logic to monitor plural instances of said object transfer to determine a normal rate of deceptive misidentification of objects and to populate said reference database.

11. The apparatus of claim 1, said model training input comprising at least one said captured image and a tag comprising at least said object identifier.

12. The apparatus of claim 1, plural instances of said model training input being accumulated to a threshold level before provision to said model-based machine learning logic.

13. The apparatus of claim 1, said transactional computing event comprising a retail transaction event.

14. The apparatus of claim 13, said retail transaction event comprising a self-checkout transaction.

15. The apparatus of claim 13, said object identifier comprising a product identification code.

16. A machine-implemented method of operating a model-based machine learning logic and inferencing logic for controlling object transfer, comprising:
receiving image data derived from at least one captured image of at least one said object;
generating a first classification of said object by activating a trained model to analyse said image data;
receiving at least one object identifier associated with said object;
generating a second classification of said object according to said at least one object identifier associated with said object;
detecting failure to reconcile said first classification and said second classification;
responsive to detecting said failure to reconcile, to determining at least one causal factor in said failure; and
when at least one said causal factor in said failure to reconcile is a deficient first classification, providing model training input comprising said image data and said object identifier to said model-based machine learning logic.

17. (canceled)

18. The method of claim 16, further comprising consulting a reference database to determine whether said deficient first classification is consistent with deceptive misidentification of an object, and rejecting said at least one captured image and said object identifier as candidates for said model training input responsive to an above-threshold probability that said discrepant features are consistent with deceptive misidentification of an object.

19. The method of claim 18, further comprising monitoring plural instances of said object transfer to determine a normal rate of deceptive misidentification of objects and to populate said reference database.

20. The method of claim 16, said transactional computing event comprising a retail transaction event.

21. (canceled)

22. The method of claim 20, said object identifier comprising a product identification code.

23. (canceled)
